(19) United States
(12) Patent Application Publication
(10) Pub. No.: US 2010/0069138 A1
(43) Pub. Date: Mar. 18, 2010

(54) PLAYER SELECTED IDENTITIES AND LUCKY SYMBOLS

(75) Inventor: John F. Acres, Corvallis, OR (US)

Correspondence Address: MARGER JOHNSON & MCCOLLOM, P.C., 210 SW MORRISON STREET, SUITE 400, PORTLAND, OR, 97204, US

(73) Assignee: ACRES-FIORE, INC., Las Vegas, NV (US)

(21) Appl. No.: 12/210,885

(22) Filed: Sep. 15, 2008

(51) Int. Cl. A63F 13/00

(52) U.S. Cl. 463/20; 463/42

(57) ABSTRACT

Embodiments of the present invention are directed to player representations used to configure indicia on a gaming device. The player representations are used to represent the identity of the player and to personalize the player's gaming experience. The player representations can be provided by the casino or by the player.

### FIELD OF THE INVENTION

This disclosure relates generally to gaming, and more particularly to player preferences used to configure the player experience while gaming.

### BACKGROUND

Gaming is a popular activity for persons of all ages. Popular games include both automated games, in which a player plays against a machine, such as slots, poker, bingo, etc., as well as those games in which a player plays against live individuals such as a dealer or other players. Gaming is enjoyed both by players who view the experience as entertainment, as well as those who pursue gaming for financial gain.

Players of games are often attracted to games with themes that relate to their own lives or preferred activities, such as television programs, sporting events, or favorite personalities.

Automated gaming machines frequently have a particular theme for a particular machine or bank of machines and a player has to travel to different machines within a casino to experience particular gaming themes. Because of the cost of machines, the diversity of player preferences sought, and the need to maximize experiences for a diverse body of players, it is possible that the experience most sought by a given player is already in use. When this occurs, a player has several options, none of which is particularly advantageous for the casino, such as the player waiting for a particular machine, the player choosing a less desirable experience which could result in the player choosing not to return on a subsequent occasion, or the player leaving the casino to pursue opportunities and experiences elsewhere.

Each of the problems described above with respect to players seeking particular experiences represents frustration for the player, unable to play the game he desires to play, and for the casino, who either has an unhappy player, players waiting to play, or players who choose to leave the casino. As a result, the need exists for players to be able to have experiences which will increase the player's enjoyment, keep the casino occupied, and keep all of the games on a given floor in use.

### BRIEF DESCRIPTION OF THE DRAWINGS

FIG. 1A is a functional block diagram that illustrates a gaming device according to embodiments of the invention.

FIG. 1B is an isometric view of the gaming device illustrated in FIG. 1A.

FIGS. 2A, 2B, and 2C are detail diagrams of exemplary types of gaming devices according to embodiments of the invention.

FIG. 3 is a functional block diagram of networked gaming devices according to embodiments of the invention.

FIGS. 4A and 4B show an example flow for the creation and application of a player representation to individual gaming machines.

### DETAILED DESCRIPTION

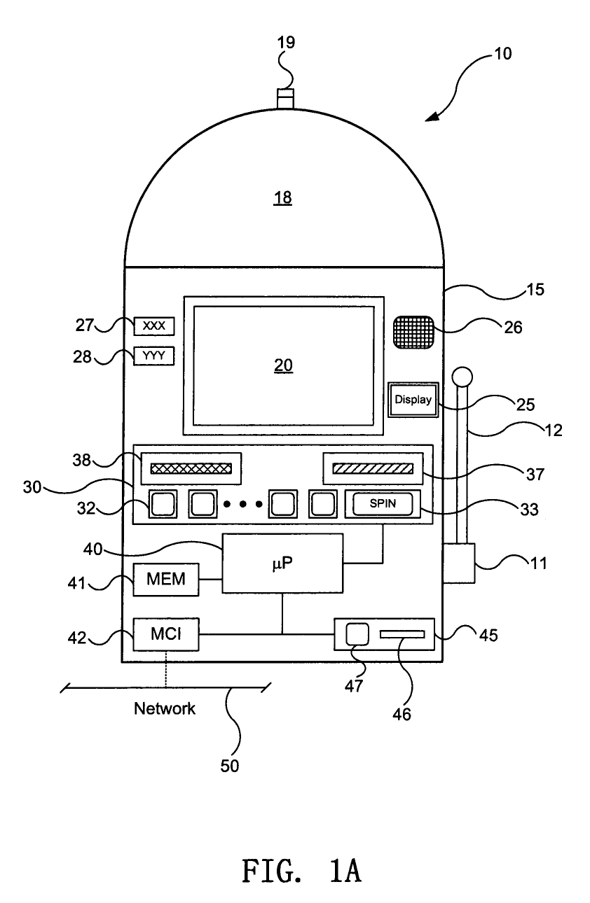

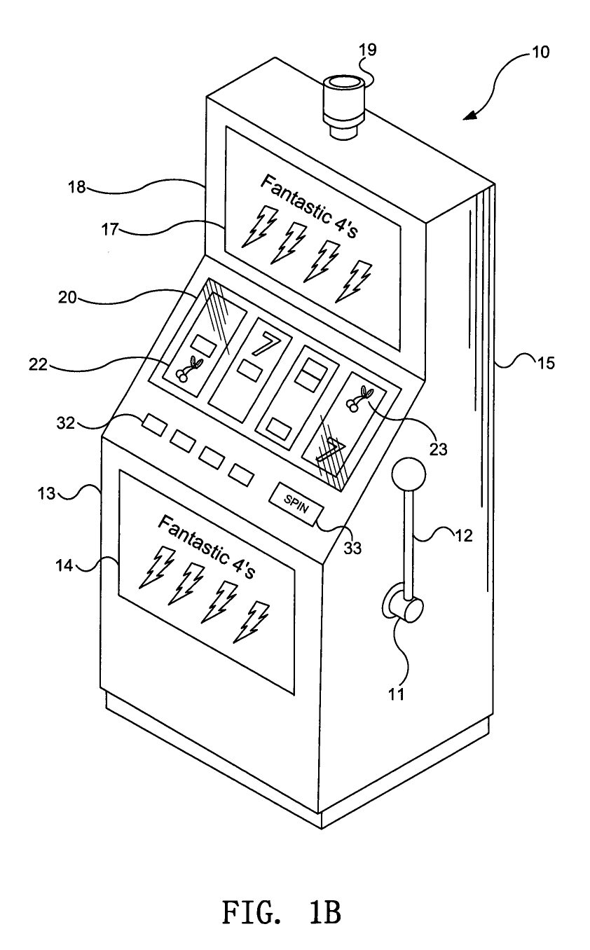

FIGS. 1A and 1B illustrate example gaming devices according to embodiments of the invention.

Referring to FIGS. 1A and 1B, a gaming device 10 is an electronic gaming machine. Although an electronic gaming machine or “slot” machine is illustrated, various other types of devices may be used to wager monetarily based credits on a game of chance in accordance with principles of the invention. The term “electronic gaming device” is meant to include various devices such as electromechanical spinning-reel type slot machines, video slot machines, and video poker machines, for instance. Other gaming devices may include computer-based gaming machines, wireless gaming devices, multi-player gaming stations, modified personal electronic gaming devices (such as cell phones), personal computers, server-based gaming terminals, and other similar devices. Although embodiments of the invention will work with all of the gaming types mentioned, for ease of illustration the present embodiments will be described in reference to the electronic gaming machine 10 shown in FIGS. 1A and 1B.

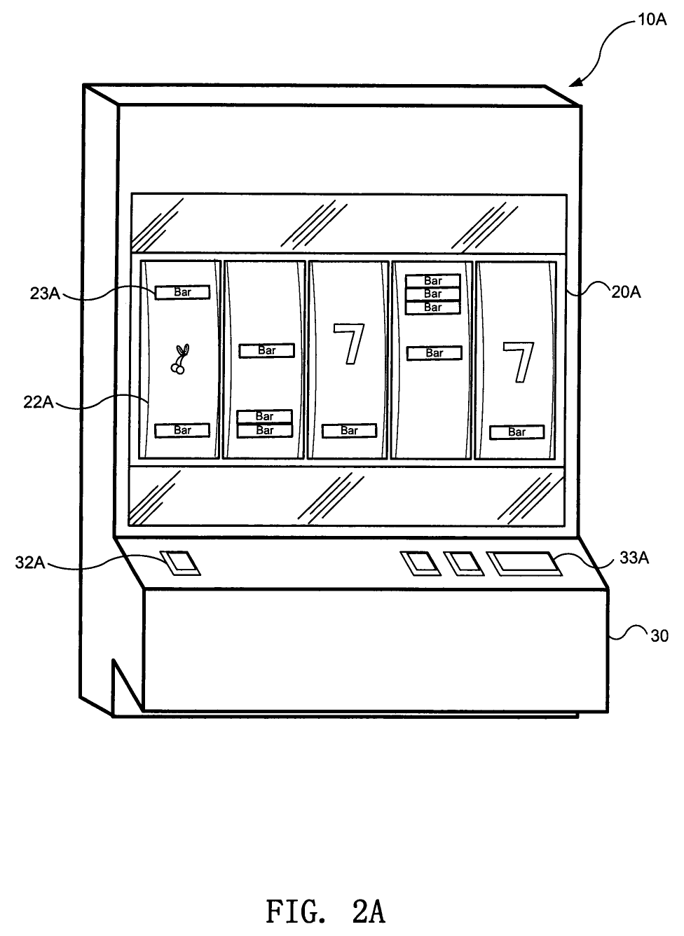

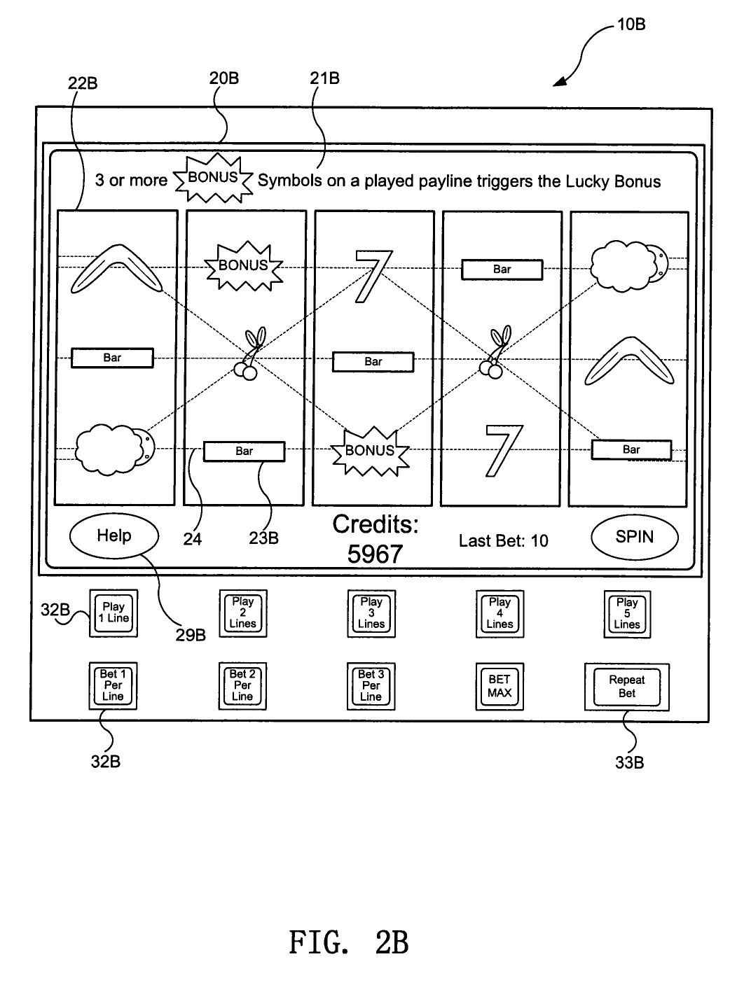

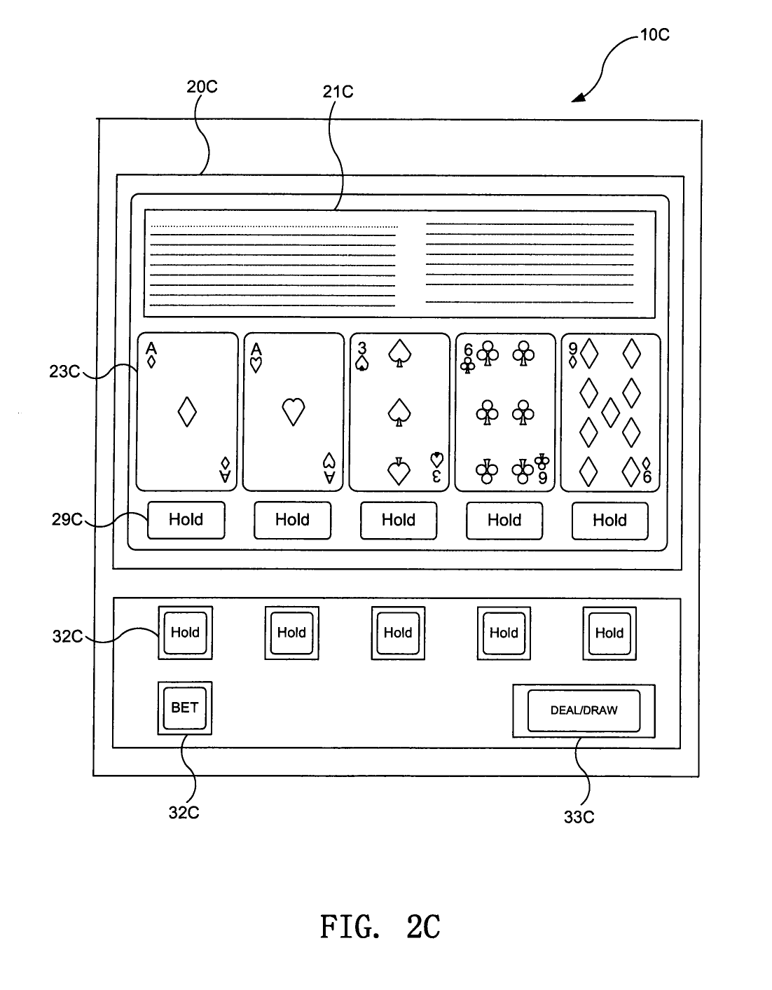

The gaming device 10 includes a cabinet 15 housing components to operate the gaming device 10. The cabinet 15 may include a gaming display 20, a base portion 13, a top box 18, and a player interface panel 30. The gaming display 20 may include mechanical spinning reels (FIG. 2A), a video display (FIGS. 2B and 2C), or a combination of both spinning reels and a video display (not shown). The gaming cabinet 15 may also include a credit meter 27 and a coin-in or bet meter 28. The credit meter 27 may indicate the total number of credits remaining on the gaming device 10 that are eligible to be wagered. In some embodiments, the credit meter 27 may reflect a monetary unit, such as dollars. However, it is often preferable to have the credit meter 27 reflect a number of ‘credits,’ rather than a monetary unit. The bet meter 28 may indicate the amount of credits to be wagered on a particular game. Thus, for each game, the player transfers the amount that he or she wants to wager from the credit meter 27 to the bet meter 28. In some embodiments, various other meters may be present, such as meters reflecting amounts won, amounts paid, or the like. In embodiments where the gaming display 20 is a video monitor, the information indicated on the credit meters may be shown on the gaming display itself 20 (FIG. 2B).

The base portion 13 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor), a mechanical bonus device (not shown), and a candle light indicator 19. The player interface panel 30 may include various devices so that a player can interact with the gaming device 10.

The player interface panel 30 may include one or more game buttons 32 that can be actuated by the player to cause the gaming device 10 to perform a specific action. For example, some of the game buttons 32 may cause the gaming device 10 to bet a credit to be wagered during the next game, change the number of lines being played on a multi-line game, cash out the credits remaining on the gaming device (as indicated on the credit meter 27), or request assistance from casino personnel, such as by lighting the candle 19. In addition, the player interface panel 30 may include one or more game actuating buttons 33. The game actuating buttons 33 may initiate a game with a pre-specified amount of credits. On some gaming devices 10 a “Max Bet” game actuating button 33 may be included that places the maximum credit wager on a game and initiates the game. The player interface panel 30 may further include a bill acceptor 37 and a ticket printer 38. The bill acceptor 37 may accept and validate paper money or previously printed tickets with a credit balance. The ticket printer 38 may print out tickets reflecting the balance of the credits that remain on the gaming device 10 when a player cashes out by pressing one of the game buttons 32 programmed to cause a ‘cashout.’ These tickets may be inserted into other gaming machines or redeemed at a cashier station or kiosk for cash.

The gaming device 10 may also include one or more speakers 26 to transmit auditory information or sounds to the player. The auditory information may include specific sounds associated with particular events that occur during game play on the gaming device 10. For example, a particularly festive sound may be played during a large win or when a bonus is triggered. The speakers 26 may also transmit “attract” sounds to entice nearby players when the game is not currently being played.

The gaming device 10 may further include a secondary display 25. This secondary display 25 may be a vacuum fluorescent display (VFD), a liquid crystal display (LCD), a cathode ray tube (CRT), a plasma screen, or the like. The secondary display 25 may show ancillary information to the player. For example, the secondary display 25 may show player tracking information, secondary bonus information, advertisements, or player selectable game options.

The gaming device 10 includes a microprocessor 40 that controls operation of the gaming device 10. If the gaming device 10 is a standalone gaming device, the microprocessor 40 may control virtually all of the operations of the gaming devices and attached equipment, such as operating game logic stored in memory (not shown) as firmware, controlling the display 20 to represent the outcome of a game, communicate with the other peripheral devices (such as the bill acceptor 37), and orchestrating the lighting and sound emanating from the gaming device 10. In other embodiments where the gaming device 10 is coupled to a network 50, as described below, the microprocessor 40 may have different tasks depending on the setup and function of the gaming device. For example, the microprocessor 40 may be responsible for running the base game of the gaming device and executing instructions received over the network 50 from a bonus server or player tracking server. In a server-based gaming setup, the microprocessor 40 may act as a terminal to execute instructions from a remote server that is running game play on the gaming device.

The microprocessor 40 may be coupled to a machine communication interface (MCI) 42 that connects the gaming device 10 to a gaming network 50. The MCI 42 may be coupled to the microprocessor 40 through a serial connection, a parallel connection, an optical connection, or in some cases a wireless connection. The gaming device 10 may include memory 41 (MEM), such as a random access memory (RAM), coupled to the microprocessor 40 and which can be used to store gaming information, such as storing total coin-in statistics about a present or past gaming session, which can be communicated to a remote server or database through the MCI 42. The MCI 42 may also facilitate communication between the network 50 and the secondary display 25 or a player tracking unit 45 housed in the gaming cabinet 15.

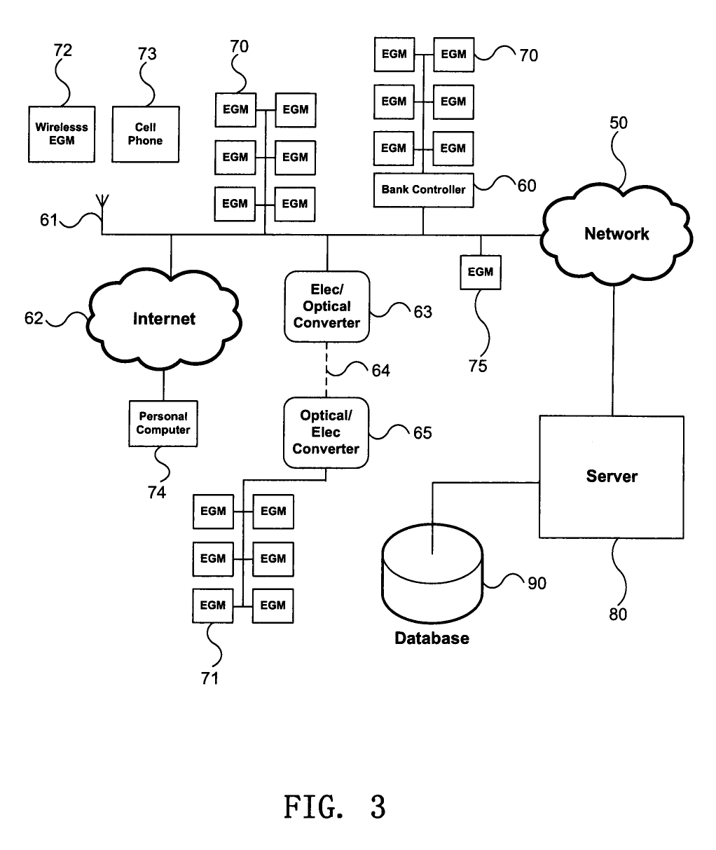

The player tracking unit 45 may include an identification device 46 and one or more buttons 47 associated with the player tracking unit 45. The identification device 46 serves to identify a player, by, for example, reading a player-tracking device, such as a player tracking card that is issued by the casino to individual players who choose to have such a card. The identification device 46 may instead, or additionally, identify players through other methods. Player tracking systems using player tracking cards and card readers 46 are known in the art. Briefly summarizing such a system, a player registers with the casino prior to commencing gaming. The casino issues a unique player-tracking card to the player and opens a corresponding player account that is stored on a server or host computer, described below with reference to FIG. 3. The player account may include the player's name and mailing address and other information of interest to the casino in connection with marketing efforts. Prior to playing one of the gaming devices in the casino, the player inserts the player tracking card into the identification device 46 thus permitting the casino to track player activity, such as amounts wagered, credits won, and rate of play.

To induce the player to use the card and be an identified player, the casino may award each player points proportional to the money or credits wagered by the player. Players typically accrue points at a rate related to the amount wagered, although other factors may cause the casino to award the player various amounts. The points may be displayed on the secondary display 25 or using other methods. In conventional player tracking systems, the player may take his or her card to a special desk in the casino where a casino employee scans the card to determine how many accrued points are in the player's account. The player may redeem points for selected merchandise, meals in casino restaurants, or the like, which each have assigned point values. In some player tracking systems, the player may use the secondary display 25 to access their player tracking account, such as to check a total number of points, redeem points for various services, make changes to their account, or download promotional credits to the gaming device 10. In other embodiments, the identification device 46 may read other identifying cards (such as driver licenses, credit cards, etc.) to identify a player and match them to a corresponding player tracking account. Although FIG. 1A shows the player tracking unit 45 with a card reader as the identification device 46, other embodiments may include a player tracking unit 45 with a biometric scanner, PIN code acceptor, or other methods of identifying a player to pair the player with their player tracking account. Alternatively, the player might have a radio-frequency identification (RFID) device and the gaming device 10 may have an RFID receiver unit, possibly in MCI 42. The player's RFID device can be an RFID-enabled card, or some other casino-issued device. The RFID receiver can also be located outside the gaming device 10 so a single RFID receiver can serve to identify players on multiple gaming devices.

During typical play on a gaming device 10, a player plays a game by placing a wager and then initiating a gaming session. The player may initially insert monetary bills or previously printed tickets with a credit value into the bill acceptor 37. The player may also put coins into a coin acceptor (not shown) or a credit card into a card reader/authorizer (not shown). The credit meter 27 displays the numeric credit value of the money inserted dependent on the denomination of the gaming device 10. That is, if the gaming device 10 is a nickel slot machine and a $20 bill inserted into the bill acceptor 37, the credit meter will reflect 400 credits or one credit for each nickel of the inserted twenty dollars. For gaming devices 10 that support multiple denominations, the credit meter 27 will reflect the amount of credits relative to the denomination selected. Thus, in the above example, if a penny denomination is selected after the $20 is inserted the credit meter will change from 400 credits to 2000 credits.

A wager may be placed by pushing one or more of the game buttons 32, which may be reflected on the bet meter 28. That is, the player can generally depress a “bet one” button (one of the buttons on the player interface panel 30, such as 32), which transfers one credit from the credit meter 27 to the bet meter 28. Each time the button 32 is depressed an additional single credit transfers to the bet meter 28 up to a maximum bet that can be placed on a single play of the electronic gaming device 10. The gaming session may be initiated by pulling the gaming handle 12 or depressing the spin button 33. On some gaming devices 10, a “max bet” button (another one of the buttons 32 on the player interface panel 30) may be depressed to wager the maximum number of credits supported by the gaming device 10 and initiate a gaming session.

If the gaming session does not result in any winning combination, the process of placing a wager may be repeated by the player. Alternatively, the player may cash out any remaining credits on the credit meter 27 by depressing the “cash-out” button (another button 32 on the player interface panel 30), which causes the credits on the credit meter 27 to be paid out in the form of a ticket through the ticket printer 38, or may be paid out in the form of returning coins from a coin hopper (not shown) to a coin return tray.

If instead a winning combination (win) appears on the display 20, the award corresponding to the winning combination is immediately applied to the credit meter 27. For example, if the gaming device 10 is a slot machine, a winning combination of symbols 23 may land on a played payline on reels 22. If any bonus games are initiated, the gaming device 10 may enter into a bonus mode or simply award the player with a bonus amount of credits that are applied to the credit meter 27.

FIGS. 2A to 2C illustrate exemplary types of gaming devices according to embodiments of the invention. FIG. 2A illustrates an example spinning-reel gaming machine 10A, FIG. 2B illustrates an example video slot machine 10B, and FIG. 2C illustrates an example video poker machine 10C.

Referring to FIG. 2A, a spinning-reel gaming machine 10A includes a gaming display 20A having a plurality of mechanical spinning reels 22A. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A may be controlled by stepper motors (not shown) under the direction of the microprocessor 40 (FIG. 1A). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to both wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

Referring to FIG. 2B, a video gaming machine 10B may include a video display 20B to display virtual spinning reels 22B and various other gaming information 21B. The video display 20B may be a CRT, LCD, plasma screen, or the like. It is usually preferable that the video display 20B be a touchscreen to accept player input. A number of symbols 23A appear on each of the virtual spinning reels 22B. Although FIG. 2B shows five virtual spinning reels 22B, the flexibility of the video display 20B allows for various reel 22B and game configurations. For example, some video slot games 10B spin reels for each individual symbol position (or stop) that appears on the video display 20B. That is, each symbol position on the screen is independent of every other position during the gaming sessions. In these types of games, very large numbers of pay lines or multiple super scatter pays can be utilized since similar symbols could appear at every symbol position on the video display 20B. On the other hand, other video slot games 10B more closely resemble the mechanical spinning reel games where symbols that are vertically adjacent to each other are part of the same continuous virtual spinning reel 22B.

Because the virtual spinning reels 22B, by virtue of being computer implemented, can have almost any number of stops on a reel strip, it is much easier to have a greater variety of displayed outcomes as compared to spinning-reel slot machines 10A (FIG. 2A) that have a fixed number of physical stops on each spinning reel 22A.

With the possible increases in reel 22B numbers and configurations over the mechanical gaming device 10A, video gaming devices 10B often have multiple paylines 24 that may be played. By having more paylines 24 available to play, the player may be more likely to have a winning combination when the reels 22B stop and the gaming session ends. However, since the player typically must wager at least a minimum number of credits to enable each payline 24 to be eligible for winning, the overall odds of winning are not much different, if at all, than if the player is wagering only on a single payline. For example, in a five line game, the player may bet one credit per payline 24 and be eligible for winning symbol combinations that appear on any of the five played paylines 24. This gives a total of five credits wagered and five possible winning paylines 24. If, on the other hand, the player only wagers one credit on one payline 24, but plays five gaming sessions, the odds of winning would be identical as above: five credits wagered and five possible winning paylines 24.

Because the video display 20B can easily modify the image output by the video display 20B, bonuses, such as second screen bonuses are relatively easy to award on the video slot game 10B. That is, if a bonus is triggered during game play, the video display 20B may simply store the resulting screen shot in memory and display a bonus sequence on the video display 20B. After the bonus sequence is completed, the video display 20B may then retrieve the previous screen shot and information from memory, and re-display that image.

Also, as mentioned above, the video display 20B may allow various other game information 21B to be displayed. For example, as shown in FIG. 2B, banner information may be displayed above the spinning reels 22B to inform the player, perhaps, which symbol combination is needed to trigger a bonus. Also, instead of providing a separate credit meter 27 (FIG. 1A) and bet meter 28, the same information can instead be displayed on the video display 20B. In addition, “soft buttons” 29B such as a “spin” button or “help/see pays” button may be built using the touch screen video display 20B. Such customization and ease of changing the image shown on the display 20B adds to the flexibility of the game 10B.

Even with the improved flexibility afforded by the video display 20B, several physical buttons 32B and 33B are usually provided on video slot machines 10B. These buttons may include game buttons 32B that allow a player to choose the number of paylines 24 he or she would like to play and the number of credits wagered on each payline 24. In addition, a max bet button (one of the game buttons 32B) allows a player to place a maximum credit wager on the maximum number of available paylines 24 and initiate a gaming session. A repeat bet or spin button 33B may also be used to initiate each gaming session when the max bet button is not used.

Referring to FIG. 2C, a video poker gaming device 10C may include a video display 20C that is physically similar to the video display 20B shown in FIG. 2B. The video display 20C may show a poker hand of five cards 23C and various other player information 21C including a paytable for various winning hands, as well as a plurality of player selectable soft buttons 29C. The video display 20C may present a poker hand of five cards 23C and various other player information 21C including a number of player selectable soft (touch-screen) buttons 29C and a paytable for various winning hands. Although the embodiment illustrated in FIG. 3C shows only one hand of poker on the video display 20C, various other video poker machines 10C may show several poker hands (multi-hand poker). Typically, video poker machines 10C play “draw” poker in which a player is dealt a hand of five cards, has the opportunity to hold any combination of those five cards, and then draws new cards to replace the discarded ones. All pays are usually given for winning combinations resulting from the final hand, although some video poker games 10C may give bonus credits for certain combinations received on the first hand before the draw. In the example shown in FIG. 2C a player has been dealt two aces, a three, a six, and a nine. The video poker game 10C may provide a bonus or payout for the player having been dealt the pair of aces, even before the player decides what to discard in the draw. Since pairs, three of a kind, etc. are typically needed for wins, a player would likely hold the two aces that have been dealt and draw three cards to replace the three, six, and nine in the hope of receiving additional aces or other cards leading to a winning combination with a higher award amount. After the draw and revealing of the final hand, the video poker game 10C typically awards any credits won to the credit meter.

The player selectable soft buttons 29C appearing on the screen respectively correspond to each card on the video display 20C. These soft buttons 29C allow players to select specific cards on the video display 20C such that the card corresponding to the selected soft button is “held” before the draw. Typically, video poker machines 10C also include physical game buttons 32C that correspond to the cards in the hand and may be selected to hold a corresponding card. A deal/draw button 33C may also be included to initiate a gaming session after credits have been wagered (with a bet button 32C, for example) and to draw any cards not held after the first hand is displayed.

Although examples of a spinning reel slot machine 10A, a video slot machine 10B, and a video poker machine 10C have been illustrated in FIGS. 2A-2C, gaming machines various other types of gaming devices known in the art are contemplated and are within the scope of the invention.

FIG. 3 is a block diagram illustrating networked gaming devices according to embodiments of the invention. Referring to FIG. 3, multiple electronic gaming devices (EGMs) 70, 71, 72, 73, 74, and 75 may be coupled to one another and coupled to a remote server 80 through a network 50. For ease of understanding, gaming devices or EGMs 70, 71, 72, 73, 74, and 75 are generically referred to as EGMs 70-75. The term EGMs 70-75, however, may refer to any combination of one or more of EGMs 70, 71, 72, 73, 74, and 75. Additionally, the gaming server 80 may be coupled to one or more gaming databases 90. These gaming network 50 connections may allow multiple gaming devices 70-75 to remain in communication with one another during particular gaming modes such as tournament play or remote head-to-head play. Although some of the gaming devices 70-75 coupled on the gaming network 50 may resemble the gaming devices 10, 10A, 10B, and 10C shown in FIGS. 1A-1B and 2A-2C, other coupled gaming devices 70-75 may include differently configured gaming devices. For example, the gaming devices 70-75 may include traditional slot machines 75 directly coupled to the network 50, banks of gaming devices 70 coupled to the network 50, banks of gaming devices 70 coupled to the network through a bank controller 60, wireless handheld gaming machines 72 and cell phones 73 coupled to the gaming network 50 through one or more wireless routers or antennas 61, personal computers 74 coupled to the network 50 through the internet 62, and banks of gaming devices 71 coupled to the network through one or more optical connection lines 64. Additionally, some of the traditional gaming devices 70, 71, and 75 may include electronic gaming tables, multi-station gaming devices, or electronic components operating in conjunction with non-gaming components, such as automatic card readers, chip readers, and chip counters, for example.

Gaming devices 71 coupled over an optical line 64 may be remote gaming devices in a different location or casino. The optical line 64 may be coupled to the gaming network 50 through an electronic to optical signal converter 63 and may be coupled to the gaming devices 71 through an optical to electronic signal converter 65. The banks of gaming devices 70 coupled to the network 50 may be coupled through a bank controller 60 for compatibility purposes, for local organization and control, or for signal buffering purposes. The network 50 may include serial or parallel signal transmission lines and carry data in accordance with data transfer protocols such as Ethernet transmission lines, firewire lines, USB lines, or other communication protocols. Although not shown in FIG. 3, substantially the entire network 50 may be made of optical lines 64 or may be a wireless network.

As mentioned above, each gaming device 70-75 may have an individual processor 40 (FIG. 1A) and memory 41 to run and control game play on the gaming device 70-75, or some of the gaming devices 70-75 may be terminals that are run by a remote server 80 in a server based gaming environment. Server based gaming environments may be advantageous to casinos by allowing fast downloading of particular game types or themes based on casino preference or player selection. Additionally, tournament based games, linked games, and certain game types, such as BINGO or keno may benefit from at least some server 80 based control.

Thus, in some embodiments, the network 50, server 80, and database 90 may be dedicated to communications regarding specific game or tournament play. In other embodiments, however, the network 50, server 80, and database 90 may be part of a player tracking network. For player tracking capabilities, when a player inserts a player tracking card in the card reader 46 (FIG. 1A), the player tracking unit 45 sends player identification information obtained on the card reader 46 through the MCI 42 over the network 50 to the player tracking server 80, where the player identification information is compared to player information records on in the player database 90 to provide the player with information regarding their player accounts or other features at the gaming device 10 where the player is wagering. Additionally, multiple databases 90 and/or servers 80 may be present and coupled to one or more networks 50 to provide a variety of gaming services, such as both game/tournament data and player tracking data.

The various systems described with reference to FIGS. 1-3 can be used in a number of ways. For instance, the systems can be used to track data about various players. The tracked data can be used by the casino to provide additional benefits to players, such as extra bonuses, bonus games, and the like. The systems can also be used to generate player representations which can be used to populate various output devices (i.e., displays and speakers) on the gaming devices to enhance the player's gaming experience. These added benefits further entice the players to play at the casino that provides the benefits. In order to utilize such benefits, the player can provide certain information at the time of establishing the player account. The casino can then use the information to customize the player's gaming experience.

Table 1 shows information that can be provided by the player at the time the player account is established or at any later time that the player account is updated. The player account can be established/updated in the casino, at a service desk or kiosk, or away from the casino using a computer or other electronic device, such as a telephone, personal digital assistant or other electronic device, or in any other manner in which information concerning the player and the player's preferences can be associated with the player's account. In addition to the player's name and address, the player has the option to provide information that can be used by the casino to configure gaming devices 10 with player-specific preferences to personalize the player's gaming experience.

TABLE 1

| Player | Method of | Exemplary Effects | Exemplary Effects |
|---|---|---|---|
| Information | Entry | on Player | on Machine |
| Name | Desk, kiosk, PC, | Personalize | Name appears on |
| | EGM, electronic | communication at the | display(s) 20, 25; |
| | device (including | machine; loyalty | Name “spoken” at |
| | phone, mp3 player, | mailings/promotions; tax | speaker 26 |
| | key fob, thumb | recording, etc. | |
| | drive, RFID) | | |
| Address | Same | Loyalty | None, unless |
| | | mailings/promotions; tax | customized by casino |
| | | recording, etc. | |
| Player Number | Same | Player tracking and | Used by player |
| | | preferences at EGM 10 | tracking unit 45 |
| Player PIN | Same | Player tracking and | Used by player |
| | | preferences at EGM 10 | tracking unit 45 |
| Avatar | Same | Personalize | Avatar appears on |
| | | communication at the | display(s) 20, 25; used |
| | | machine; player tracking; | by player tracking unit |
| | | used as log-on | 45; used as log-on |
| Sounds | Same | Personalize sounds at | Played at speaker 26 |
| | | EGM 10 | |
| Lucky Symbols | Same | Personalize play at EGM | Replaces default |
| | | 10 | settings (such as reel |
| | | | symbols, appearance of |
| | | | virtual cards) |
| Machine Speed | Same | Speeds up/slows play at | Changes rate of play at |
| | | the EGM 10 for player | EGM 10 in response to |
| | | preference | player preference |
| Event ordering | Same | Personalizes machine | Alters the order in |
| | | events, such as manner | which machine events |
| | | in which reels stop | occur |
| | | (synchronous v. | |
| | | staggered) | |
| Colors | Same | Personalizes play at the | Changes default |
| | | EGM 10 | settings for colors |
| | | | appearing at the EGM |
| | | | 10 |

Player preferences can include, for example, a player representation, such as an avatar, a photo, or other image. The player representation can be any image or design that the player chooses and can be for example a representation of the player himself, the player's child, a favorite pet, home, vacation spot, etc. By selecting such a player representation, the player can be assured that his play is being associated with his player account (by seeing the player representation in the gaming display 20, for example). The preferences can also include, as examples, favorite songs or sounds, favorite colors, or favorite lucky symbols to be applied to the gaming machine 10. Other types of preferences that can be selected by the player are those related to gaming device graphics, such as writing or images, the speed at which machine events occur and, for example, the manner in which reels spin and stop, such as whether they are synchronous or staggered. In other words, the player preferences can be used to provide additional content on the gaming device 10 (i.e. show an avatar in the gaming display 10) and/or to modify existing content and gameplay (i.e. replace the default symbols on the reels 22B or change the speed of the reels).

In establishing preferences, the player can select the standard settings applied by the casino to individual accounts or types of individual accounts, such as settings used for all players, settings used for players of a particular sex, settings used for players of a particular age or age bracket, settings applied by region, etc. Alternatively, a player can select the preferences to be applied to the player's experience from a menu of available settings, such as those for a particular sex, those for players by age, those for players by region, those relating to particular sports or sports teams, those relating to favorite movie stars, those relating to favorite colors, etc. Additionally, the player can select settings that do not have any particular connection with the player other than that the settings appeal to the player.

As discussed above, the player account can be established/updated in the casino, at a service desk, kiosk, or gaming machine, or away from the casino using a computer or other electronic device. These can be referred to collectively as input devices. At these input devices, the player may interact with a touch screen to select the desired preferences to add to their player account. For example, the player may be presented with a list of available preferences and the player may ‘drag-and-drop’ the desired preference(s) into a visual representation of their player account. Alternatively, the player can select the desired preference by simply touching the desired preference in a list. The list of available preferences may form a nested or hierarchical structure in which categories of preferences are displayed first and selection of a preference category leads to display of sub-categories or individual preferences. As examples, preference categories can be university sports teams, time period themes, animal lovers, and the like. One of the preference categories may refer to player provided content and selection of this category can lead to a directed interaction between the player and the input device that allows the player to upload content such as images or sounds.

Table 2 shows information which can be obtained from a player in order to generate player representations to further enhance the player's experience and to personalize that experience.

TABLE 2

| Player | Source of the | Location on |
|---|---|---|
| Representations | Representations | Gaming Device |
| Images | Upload (home or casino); | Display 20, 25 |
| | USB; mp3; telephone | |
| Sounds | Upload (home or casino); | Speaker 26 |
| | USB; mp3; telephone | |
| Lucky Symbols | Upload (home or casino); | Display 20, 25 |
| | USB; mp3; telephone | Reels 22; |
| | | Symbols 23; |
| Colors | Upload (home or casino); | Display 20, 25 |
| | USB; mp3; telephone | |

As an example, a player might choose to be represented by a particular image during game play, such as an avatar, or a favorite photograph of the player or someone or something associated with the player, such as a favorite animal, a relative, or a favorite team. By uploading the image to the player tracking account, the player is able to personalize his gaming experience and to incorporate the image into the player's gaming experience. Likewise, a player might choose to be represented by a favorite sound or favorite piece of music. By uploading the sound to the player account, the player is able to use the sound as both a representation, and to have the sound played during celebrations or other portions of the gaming experience. Similarly, a player can upload a favorite Lucky Symbol or color to represent the player during the player's play on the gaming machine.

Configuration of player preferences varies slightly depending on the type of gaming device involved. Referring to FIG. 2A, reels, as described above, may be controlled by stepper motors under the direction of microprocessor 40. As a result, virtual reel strips are stored in memory 41 of the gaming device 10. Thus, virtual stops are mapped to each physical stop on the physical reel 22A, and configuring the reels 22A with player lucky symbols, results in mapping the lucky symbols selected by the player to the virtual reels 22A stored in memory 41. Play proceeds as set forth above with respect to FIG. 2A.

Referring to gaming devices 10 as set forth in FIG. 2B, a video gaming machine 10B includes a video display 20B to display virtual spinning reels 22B and various other gaming information 21B, such as player selected gaming identity or avatar. Rather than casino-selected symbols 23B appearing on each of the virtual spinning reels 22B, the casino-selected symbols are replaced with player-selected lucky symbols when the player's account is transmitted to the appropriate gaming device, as described above. Play proceeds as set forth above with respect to FIG. 2B.

Referring to gaming devices as set forth in the FIG. 2C, a video poker gaming device 10C may include a video display 20C that is similar to the video display 20B shown in FIG. 2B. The video display 20C may show a poker hand of five cards 23C and various other player information 21C, such as a player identity. The video poker machines 10C deal a hand of five cards 23C to which the player-selected lucky symbols, such as a favorite team logo, are graphically displayed. Play proceeds as set forth above with respect to FIG. 2C.

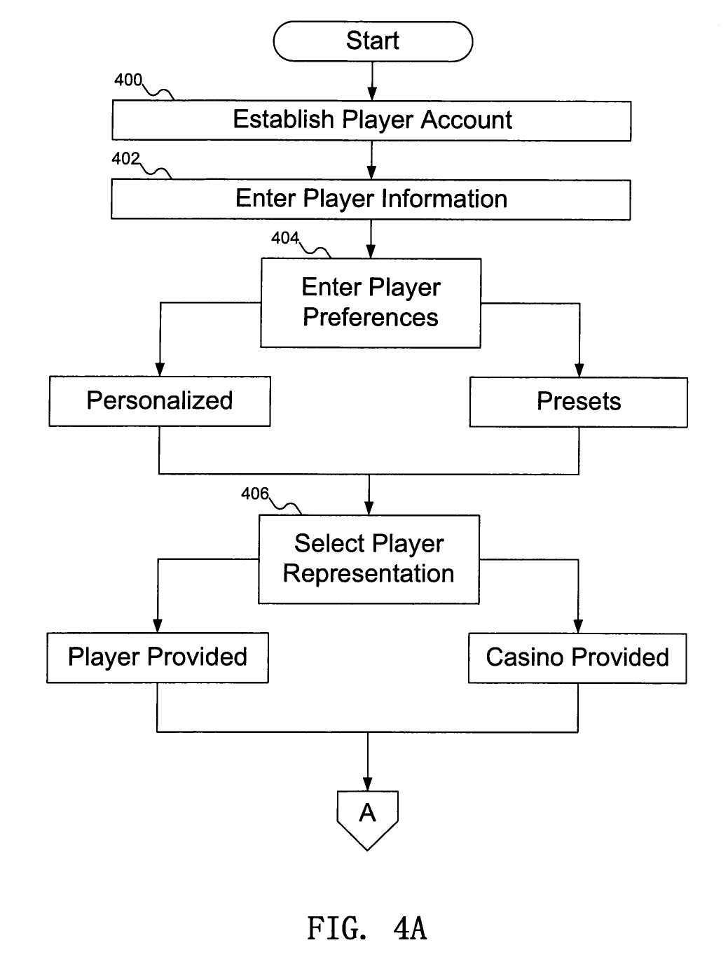

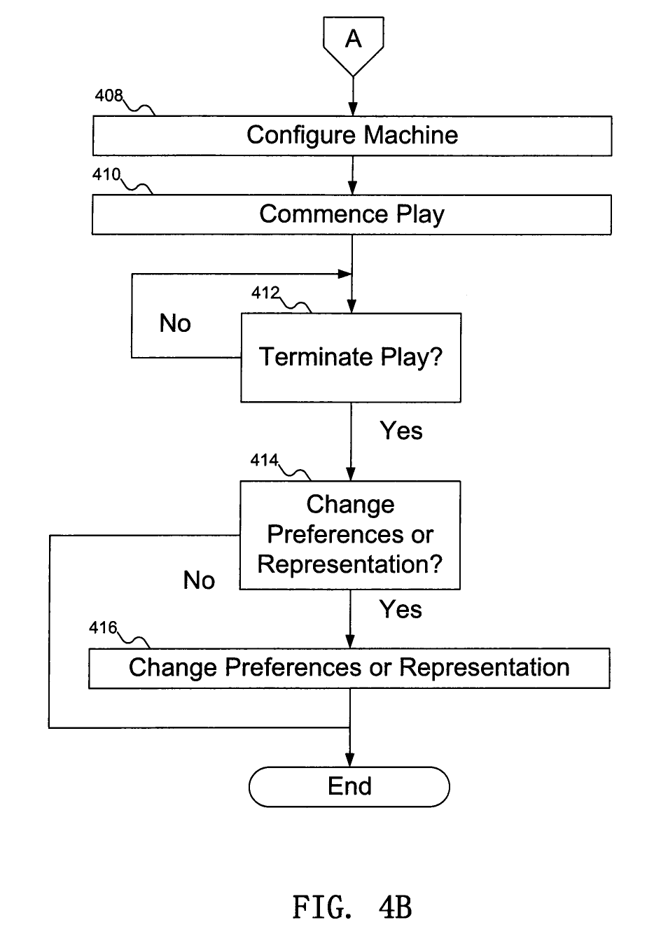

FIGS. 4A and 4B show an example flow for the creation and application of a player representation to individual gaming machines 10. Referring to FIGS. 4A and 4B, at a process 400, the player establishes a player account. As described above, this can be done either at the casino, at the player's home, or from a mobile device. At a process 402, the player provides information relating to his account, such as his name and address. The casino can provide a player number or other identifier to designate the player's account and provide the player with a card or other device for activating the player's account at a particular gaming machine 10. The casino, at the player and casino's option, can likewise enable the player to select a personal identification number (PIN) to access the player's account without the need of a card or other device.

As part of the creation of the player account, the player can, but need not, select certain preferences which become configuration settings at a process 404. These player preferences can include the information set forth in Table 1 above, or can include other settings provided by the casino. For example, a player can select sounds or visual images to be played at a gaming machine. The player selected sounds or visual images can be chosen from a list of currently available sounds or images available through the casino database, or can be player selected sounds or visual images which the player brings or transmits to the casino for application to the player's account, such as through the internet, mp3 files, a telephone, and the like. Also, the player's preferences can include combinations of sounds or images contained both in the casino database and brought or transmitted by the player.

At process 404, the player can likewise make selections as to how preferred sounds and or images are incorporated into the player's gaming experience. For example, sounds and images can be used in greetings, announcements, win notifications, and in game play. When used in game play, sounds or images can be used, for example, as symbols on a reel, symbols on cards used in a video poker game, etc. At process 404, the player can also establish preferences involving the operation of the machine, such as the speed at which machine events occur and the ordering of events.

At a process 406, the player can select a given image or sound to represent the player during the player's play on the machine. For example, the player's image can appear on a secondary screen 25 associated with the game display during game play, or on a primary 20 or secondary screen 25 at the time the player's card is entered into the card reader 46 (or any other time the player identifies himself to the machine).

At a process 408, the player's preferences are configured (or published) on the machine being played by the player when play is initiated. Play can be initiated by, for example, the player's play card being entered into the card reader 46 associated with the gaming device 10, the player entering a PIN number into the gaming device 10, or other methods. When play is initiated, the player can be welcomed to the machine by reference to the player's representative image or sound.

At a process 410, the player undertakes play of the gaming device and plays until the player desires to stop at a process 412. Prior to withdrawal of the player's player card (or the player leaving the gaming device 10), the player can be asked whether he wants to change any of his player preferences or player representation at process 414. If the player desires such a change, the player enters the change at the gaming device in a process 416. The changes to the player's preferences and/or representation are similar to those described above with respect to processes 404 and 406. Once the player has entered the desired changes, the player's card can be removed from the gaming device for play on a different gaming device or the player can simply leave the gaming device if a player card is not used at a process 418. It is understood that configuration and representation changes can occur throughout the casino environment through help desks, kiosks, etc., and that preference and representation changes can occur in a single step or multiple steps, and at any time during game play.

An example of the flow in FIG. 4 is as follows: Player A, residing in Gainesville, Fla., is an avid University of Florida fan and his avatar is a representation of himself wearing his favorite Gator apparel. Player A is also an enthusiast of the Gator fight song. Player A plays both the slot machines and video poker and wants to personalize his casino experience with his preferences. Player A makes his selections with the aid of a casino representative at a help desk; although Player A could likewise make his selections at a kiosk or at home using his home computer before arriving at the casino.

When establishing his player account, Player A decides to establish preferences for his play in the casino, rather than accepting the default selections set by the casino. For example, Player A wishes to have his avatar displayed on a display 20 associated with the gaming device or on a secondary display 25 associated with the gaming device. Player A has copied his avatar to a USB drive which he presents to the casino representative for copying to his player account. Player A elects to have the Gator fight song play on the speakers 26 associated with the gaming device 10 as the preferred song for particular events that occur during play on the gaming device 10, such as festive sounds played during a large win or when a bonus is triggered. Player A has also included a digital version of the fight song on the USB drive he presented to the casino representative for copying to his player account.

Player A further elects to replace the standard reel symbols 23, shown in FIGS. 2A and 2B with college football-themed reels 22 for each of the three to five reels appearing on the games in the casino. Because the casino had a pre-set option for college football teams, Player A is able to choose from a pre-defined menu of reel themes and is thus not required to bring images for the various football teams. Player A is given the option to select which reel combinations a particular team corresponds to, and naturally selects the University of Florida team logo for the highest value combination. Player A likes the excitement of waiting for the spinning reels 22A in FIG. 2A to stop so he selects the option that has them stopping one after another until finished, as opposed to stopping simultaneously. Player A also elects to use his preferences with video poker gaming machines, shown in FIG. 2C, and selects the University of Florida team logo to appear on virtual cards dealt during video poker play.

Player A, and other players, can likewise copy information from their home computers to their player account, use a personal digital device such as an mp3 player, or use a cellular telephone to establish their gaming preferences. Player A has chosen to personalize all available features for his account preferences, but could likewise have chosen from shorter menus of personalization, such as simply having his avatar or image appear, or configuring the reels with his favorite colors as his lucky symbols. The amount and number of preferences a given player can set are limited only by the time the player and casino wish to invest in the configuration process.

Depending on the system used, the player account information, including configuration preferences, is transmitted through a process 404 to the player tracking unit 45 and stored with other player identifying data. At a process 406 the player preferences, or configuration settings, are applied to the gaming device 10 associated with the player account. When Player A stops play on a particular gaming machine 10, whether caused by removal of a player card, the expiration of all credits, or after a pre-set time delay, the machine is restored to its default conditions. Player preferences can also be communicated to the gaming machine 10 via a touch screen device associated with the gaming display 20 or secondary display 25. In this way, Player A's gaming experience can be tailored to his individual interests and thus Player A may be more likely to play at a casino that allows such customization. Further, Player A does not have to waste time waiting for a particular gaming device to become available in order to obtain the desired gaming experience.

In accordance with embodiments of the invention, a player can choose player preferences and player representations to be associated with the player account. The preferences and representations can be selected from those available at the casino or they may be provided by the player. The player preferences and representations can then be applied to any gaming device that the player chooses to play in the casino. Accordingly, the player's gaming experience can be enhanced and the casino can avoid having players waiting for particular machines or leaving the casino due to the unavailability of particular machines.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A method of configuring a gaming device, comprising:
establishing a player profile including one or more representations, at least one of which is player-provided;
associating the player profile with one or more gaming devices; and
publishing the one or more representations on an output device associated with the one or more gaming devices.

2. The method of claim 1, wherein publishing the one or more representations on the output device comprises publishing the one or more representations as a reel symbol on a reel associated with a display.

3. The method of claim 1, wherein establishing the player profile occurs at the gaming device.

4. The method of claim 1, wherein establishing the player profile occurs away from the gaming device.

5. The method of claim 1, wherein the one or more representations includes a representation of the player.

6. A method of configuring a gaming device, comprising:
establishing a player profile including a player-provided representation; and
applying the representation to a gaming device.

7. The method of claim 6, wherein applying the representation to a gaming device comprises applying the representation to an output device associated with the gaming device.

8. The method of claim 7, wherein the representation is an image representing the player.

9 The method of claim 7, wherein the image is an avatar.

10. The method of claim 7, wherein the player-provided representation is a sound.

11. The method of claim 10, further comprising a visual representation.

12. The method of claim 7, wherein the representation is selected by the player at the gaming device.

13. A method of identifying a player of games of chance comprising:
creating a player representation; and
applying the player representation to one or more output devices associated with a game of chance.

14. The method of claim 13, wherein the player creates the player representation.

15. The method of claim 13, wherein the player representation is applied as a reel symbol on a reel associated with the one or more output devices.

16. The method of claim 13, wherein the player representation is applied as a player identity on the one or more output devices.

17. The method of claim 13, wherein creating a player representation comprises creating a menu of pre-defined player representations, at least one of which is provided by a player, and selecting one or more of the player representations from the menu of pre-defined player representations.

18. A method of creating a player identity comprising;
determining a player to receive a player representation;
selecting a player representation for the player; and
configuring a plurality of indicia associated with a game of chance in response to the selection.

19. The method of claim 18, wherein the player representation is selected by the player.

20. The method of claim 18, wherein the player representation is an image.

21. The method of claim 20, wherein the image is an avatar.

22. The method of claim 18, wherein configuring a plurality of indicia comprises configuring a display associated with the game of chance.

23. The method of claim 22, wherein configuring a plurality of indicia comprises configuring a reel symbol on a reel associated with the display.

24. A gaming device comprising:
an output device; and
a controller structured to present a representation chosen by the player on the output device.

25. The device of claim 24, further comprising a reel associated with the output device.

26. The device of claim 25, wherein the controller is structured to present the representation as a reel symbol on the reel.

27. The device of claim 24, wherein the representation is supplied by the player at the gaming device.

28. The device of claim 24, wherein the representation is supplied by the player away from the gaming device.

29. The device of claim 24, wherein the representation is a lucky symbol.

30. The device of claim 29, where in the representation is an avatar.

31. The device of claim 24, wherein the representation is chosen from a menu of available player-supplied representations.

32. The device of claim 24, further comprising a second reel.

33. The device of claim 32, further comprising a third reel.

34. A gaming device comprising:
an output device; and
a controller associated with the output device, wherein the controller is structured to configure the output device in response to a selection of a player representation.

35. The device of claim 34, wherein the player representation is an avatar.

36. The device of claim 34, wherein the selection of the player representation occurs at the gaming device.

37. The device of claim 34, wherein the selection of the player representation occurs away from the gaming device.

38. A gaming device comprising:
a display;
a reel associated with the display;
a plurality of reel symbols associated with the reel; and
a controller structured to present a representation supplied by the player on the display apart from the reel and on one or more reel symbols.

39. A gaming system, comprising:
one or more gaming devices, each of the one or more gaming devices including a controller structured to configure an output device in response to a selection of a player representation;
a gaming server;
a network connecting the gaming server to the one or more gaming devices; and
a database connected to the gaming server, the database storing a player account including the player representation,
wherein the gaming server is configured to provide the player representation from the database to each of the one or more gaming devices.

40. The gaming system of claim 39, wherein the output device is a display and the controller is structured to present the player representation as a reel symbol on a reel in the display.

41. The gaming system of claim 39, wherein the player representation is supplied by the player at one of the one or more gaming devices.

42. The gaming system of claim 39, wherein the player representation is supplied by the player away from the one or more gaming devices.

43. The gaming system of claim 39, wherein the player representation is chosen from a menu of available player-supplied representations.

44. The gaming system of claim 39, wherein the output device is a speaker and the controller is structured to present the player representation as an audible noise emitted from the speaker.
